(19) United States
(12) Patent Application Publication
(10) Pub. No.: US 2026/0286754 A1
(43) Pub. Date: Sep. 24, 2026

(54) HIDDEN SLIDING DOOR SYSTEM

(71) Applicant: ASSA ABLOY Accessories and Door Controls Group, Inc., Monroe, NC (US)

(72) Inventors: Varun Subramoniam, Olive Branch, MS (US); Gina Karen Gomez Perez, Cordova, TN (US); Audomsoewanyque Houy, Memphis, TN (US)

(73) Assignee: ASSA ABLOY Accessories and Door Controls Group, Inc., Monroe, NC (US)

(21) Appl. No.: 19/562,052

(22) Filed: Mar. 10, 2026

Related U.S. Application Data
(60) Provisional application No. 63/773,838, filed on Mar. 18, 2025.

(51) Int. Cl. E05D 15/06

(52) U.S. Cl. CPC E05D 15/063; E05D 15/0656; E05Y 2201/684; E05Y 2600/12; E05Y 2600/314; E05Y 2600/452; E05Y 2900/132

(57) ABSTRACT

A sliding door system including a door, a hidden slide assembly including an upper track, a hanger assembly, and a bottom slide assembly. The hanger assembly including a hanger mount coupled to a wall and a hanger carriage coupled to the hanger mount and the upper track. The hidden slide assembly may further include a primary safety assembly including a flexible member configured to restrict the door from disengaging with the hanger mount when the hanger carriage disengages from the upper track, disengages from the hanger mount, or fails. Furthermore, embodiments of the invention may include one or more vertical adjustment assemblies, and one or more planar adjustment assemblies configured to adjust the position of the hanger mount and hanger carriage relative to one another, and thus the position of the sliding door.

### CROSS REFERENCE AND PRIORITY CLAIM UNDER 35 U.S.C. §119

This application claims priority to U.S. Provisional Application No. 63/773,838 entitled “Hidden Sliding Door System” filed on March 18, 2025, which is assigned to the assignee hereof and the entirety of which is incorporated by reference herein.

### FIELD

This application relates generally to the field of sliding doors, and more particularly, to a hidden sliding door system and the components thereof.

### BACKGROUND

Doors, in particular sliding doors, open and close utilizing hardware such as brackets, rails, and wheels which allow the doors to slide along a set path of movement. In conventional sliding door systems, sliding door hardware is mounted above the door and/or to a rear face of a sliding door, which requires additional space around the door (e.g., above, adjacent, or the like) to mount the hardware and operate the door. Thus, there is a need for a sliding door system which provides improved mounting and safety assemblies for such mounting.

### BRIEF SUMMARY

The present invention relates generally to a sliding door system. Specifically, the sliding door system comprises a door having a front face, a rear face, a top edge, a bottom edge, a leading edge, and a trailing edge. The system may also include a hidden slide assembly, the hidden slide assembly including an upper track coupled adjacent the top edge of the door, the upper track comprising a leading track end adjacent the leading edge of the door and a trailing track end adjacent the trailing edge of the door, as well as a hanger assembly comprising a hanger mount coupled to a wall and a hanger carriage coupled to the hanger mount and the upper track. The hidden slide assembly may further comprise a primary safety assembly and/or a secondary safety assembly. The system may further include a bottom slide assembly coupled adjacent the bottom edge of the door.

One embodiment of the invention is a sliding door system. The system comprises a door having a front face, a rear face, a top edge, a bottom edge, a leading edge, and a trailing edge. The system further comprises a hidden slide assembly. The hidden slide assembly comprises an upper track coupled adjacent the top edge of the door, the upper track comprising a leading track end adjacent the leading edge of the door and a trailing track end adjacent the trailing edge of the door. The hidden slide assembly further comprising a hanger assembly comprising a hanger mount coupled to a wall, and a hanger carriage coupled to the hanger mount and the upper track. The system further comprising a bottom slide assembly coupled adjacent the bottom edge of the door.

In further accord with embodiments of the invention, the hidden slide assembly further comprises a primary safety assembly. The primary safety assembly comprises a flexible member coupled adjacent to the leading edge or the trailing edge of the door and coupled to the hanger mount or a safety mount. The flexible member restricts the door from disengaging with the hanger mount or the safety mount when the hanger carriage disengages from the upper track, when the hanger carriage disengages from the hanger mount, or when the hanger carriage fails.

In other embodiments, the hanger mount comprises one or more guides, and wherein the one or more guides are coupled to the flexible member.

In yet other embodiments, a guide of the one or more guides comprises a tubular member having an opening, wherein the flexible member passes through the opening.

In still other embodiments, the primary safety assembly further comprises one or more tensioning assemblies. A tensioning assembly comprises a tension adjustment mechanism configured to tension or loosen the flexible member.

In other embodiments, the primary safety assembly further comprises a first tensioning assembly coupled to the leading track end, and a second tensioning assembly coupled to the trailing track end.

In further accord with embodiments, the flexible member is coupled to the leading track end and the trailing track end.

In other embodiments, the flexible member comprises at least a portion that is flexible.

In yet other embodiments, the hidden slide assembly further comprises a secondary safety assembly. The secondary safety assembly comprises one or more arms coupled to the hanger mount or the hanger carriage and extending over the at least a portion of the upper track. When the hanger carriage disengages from the upper track or the hanger carriage fails, the one or more arms engage the portion of the upper track to restrict the door from disengaging with the hanger mount or the hanger carriage.

In still other embodiments, the rear face comprises an upper channel extending transversely between the leading edge and the trailing edge of the door and the upper track is positioned within the upper channel.

In other embodiments, the hidden slide assembly further comprises a first roller stop coupled adjacent the leading edge of the door, and a second roller stop coupled adjacent the trailing edge of the door. The hanger carriage has a travel path that is constrained between the first roller stop and the second roller stop.

In further accord with embodiments, the hanger carriage further comprises one or more vertical adjustment assemblies. Each of the one or more vertical adjustment assemblies is configured to adjust a vertical position of a hanger carriage end of the hanger carriage with respect to the hanger mount.

In other embodiments, the one or more vertical adjustment assemblies comprise a vertical adjustment mount coupled to the hanger mount, a vertical adjustment aperture formed by the hanger carriage, and a threaded fastener coupled to the vertical adjustment mount and the vertical adjustment aperture.

In yet other embodiments, the hanger carriage further comprises one or more planar adjustment assemblies configured to adjust a distance between the hanger carriage and the hanger mount.

In still other embodiments, a planar adjustment assembly comprises a horizontal adjustment mount coupled to the hanger mount having a slotted aperture, a horizontal adjustment aperture formed by the hanger carriage, and a threaded fastener coupled to the horizontal adjustment mount and the horizontal adjustment aperture.

In other embodiments, the hanger assembly further comprises a first soft-close assembly coupled adjacent the leading edge of the door, and a second soft-close assembly coupled adjacent the trailing edge of the door. The first soft-close assembly and the second soft-close assembly each comprise a damper configured to removably engage with the hanger carriage.

In further accord with embodiments, the bottom slide assembly comprises one or more roller assemblies coupled adjacent to the bottom edge of the door, and one or more bottom guides coupled to the floor or adjacent to the bottom edge of the door. The one or more roller assemblies support the weight of the door, and the one or more bottom guides are configured to maintain a consistent distance between the wall and the bottom edge of the door during opening and closing.

In other embodiments, the door comprises a bottom channel extending transversely between the trailing edge of the door and the leading edge of the door. The channel is positioned within the bottom edge of the door. A bottom guide of the one or more bottom guides comprises a guide pin coupled to the floor, and the guide pin slides within the channel and restricts the bottom edge of the door from moving horizontally.

Another embodiment of the invention comprises a method of installing the sliding door system by installing the hidden slide assembly to a door opening surface and the door.

Another embodiment of the invention is a sliding door system for a door having a front face, a rear face, a top edge, a bottom edge, a leading edge, and a trailing edge. The system comprises a hidden slide assembly. The hidden slide assembly comprises an upper track configured to be coupled adjacent the top edge of the door. The upper track comprising a leading track end adjacent the leading edge of the door and a trailing track end adjacent the trailing edge of the door. The hidden slide assembly further comprises a hanger assembly comprising a hanger mount configured to be coupled to a wall, and a hanger carriage configured to be coupled to the hanger mount and the upper track. The system further comprises a bottom slide assembly configured to be coupled adjacent the bottom edge of the door.

To the accomplishment of the foregoing and the related ends, the one or more embodiments of the invention comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF DRAWINGS

The accompanying drawings, which illustrate embodiments of the invention, and which are not necessarily drawn to scale, are as follows:

FIG. 1A illustrates a front perspective view of a hidden sliding door system, in accordance with embodiments of the present disclosure;

FIG. 1B illustrates a rear perspective view of the hidden sliding door system, in accordance with embodiments of the present disclosure;

FIG. 1C illustrates a partial perspective view of the hidden sliding door system, in accordance with a embodiments of the present disclosure.

FIG. 1D illustrates a perspective view of the hidden sliding door system installed with the door in an open position, in accordance with embodiments of the present disclosure.

FIG. 1E illustrates a perspective view of the hidden sliding door system with the door removed, in accordance with embodiments of the present disclosure;

FIG. 2A illustrates a perspective view of an upper track assembly of the hidden sliding door system, in accordance with embodiments of the present disclosure;

FIG. 2B illustrates a perspective view of one end of the upper track assembly of the hidden sliding door system, in accordance with embodiments of the present disclosure;

FIG. 2C illustrates an end view of the upper track assembly of the hidden sliding door system, in accordance with embodiments of the present disclosure;

FIG. 2D illustrates a perspective view of an end of the upper track assembly of the hidden sliding door system, in accordance with embodiments of the present disclosure;

FIG. 3A illustrates a rear perspective view of a hanger assembly of the hidden sliding door system, in accordance with embodiments of the present disclosure;

FIG. 3B illustrates a front perspective view of the hanger assembly of the hidden sliding door system, in accordance with embodiments of the present disclosure;

FIG. 3C illustrates a side perspective view of the hanger mount of the hanger assembly with the hanger carriage removed, in accordance with embodiments of the present disclosure;

FIG. 3D illustrates a front perspective view of the hanger carriage of the hanger assembly with the hanger mount removed, in accordance with embodiments of the present disclosure;

FIG. 4A illustrates a perspective view of a first safety assembly and hanger assembly of the hidden sliding door system, in accordance with embodiments of the present disclosure;

FIG. 4B illustrates a perspective end view of a second safety assembly and hanger assembly of the hidden sliding door system, in accordance with embodiments of the present disclosure; and

FIG. 5A illustrates a perspective view of a bottom track assembly of the hidden sliding door system, in accordance with embodiments of the present disclosure;

FIG. 5B illustrates a perspective view of the end of the bottom track assembly of the hidden sliding door system, in accordance with embodiments of the present disclosure;

FIG. 5C illustrates a partial perspective view of the end of bottom track assembly with a bottom track and roller housing removed, in accordance with embodiments of the present disclosure; and

FIG. 6 is a method of installing the hidden sliding door system, in accordance with embodiments of the present disclosure.

### DETAILED DESCRIPTION

Embodiments of the present disclosure now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

The present disclosure relates to apparatuses, systems, and/or methods for providing a sliding door with hidden hardware that reduces the envelop needed to assemble the hardware (e.g., allowing the sliding door to be hung within reduced areas), provides improved appearances of the sliding door (e.g., at least a portion of the hardware is hidden), and/or provides improved safety in the event the hidden hardware becomes damaged. In particular, the present disclosure relates to a hidden sliding door system 100 including a door 110, a hidden slide assembly 200, and a bottom slide assembly 600, as will be described in further detail herein.

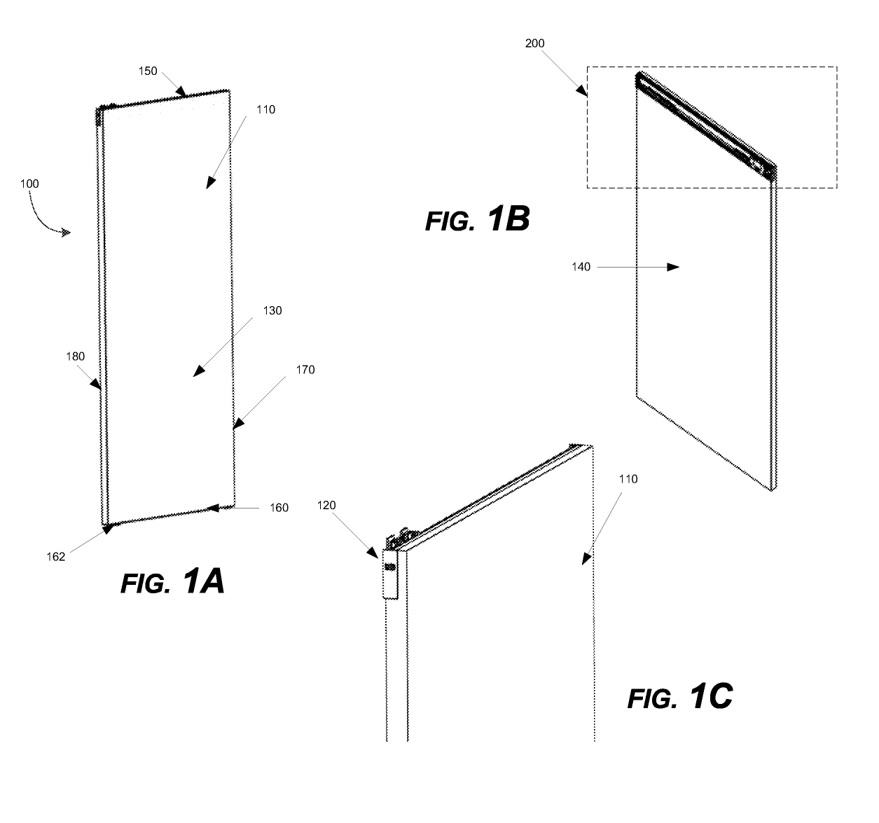

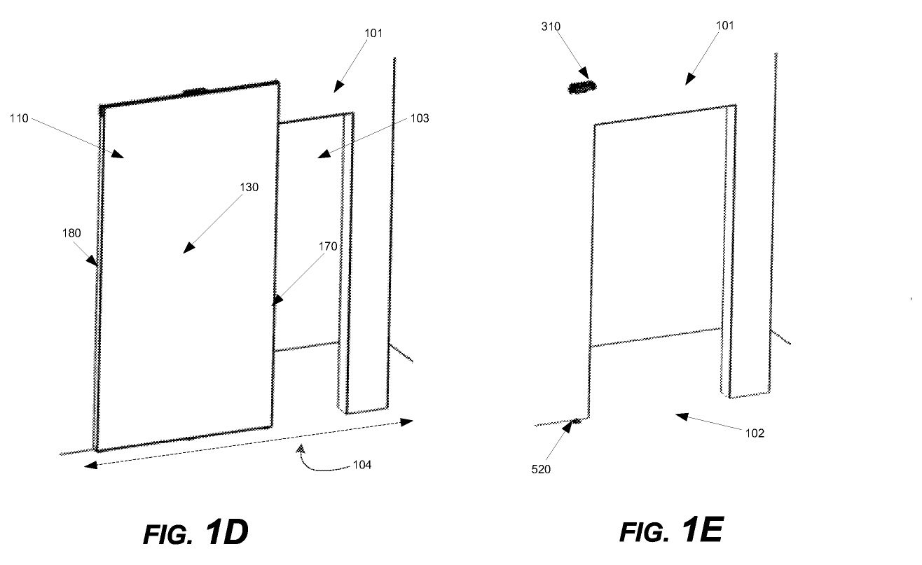

As illustrated in FIG. 1A-1E, the hidden sliding door system 100 includes one or more sliding doors 110, which may be any type of sliding door 110, such as but not limited to sound rated sliding doors, bypass doors, barn sliding doors, bi-part sliding doors, or any other type of sliding door. As such, it should be understood that when discussing “a sliding door” herein, this may refer to any type of sliding door, and/or one or more sliding doors (e.g., such as bi-part sliding doors, or the like). Regardless of the type of sliding door 110, the sliding door 110 may have edges, such as a top edge 150, a bottom edge 160, a leading edge 170, and a trailing edge 180 and opposing faces, such as a first face 130 (e.g., a front face, which may face away from a wall or frame member) and a second face 140 (e.g., a back face, which may face towards a wall or frame member). In some embodiments, the one or more sliding doors 110 may be hollow, solid, sound rated, projectile resistant (e.g., ballistic resistant, forced entry resistant, or the like), weather resistant, electromagnetic resistant, thermal resistant, or the like, and as such, the sliding doors 110 may include a specialized core to achieve one or more of the above benefits.

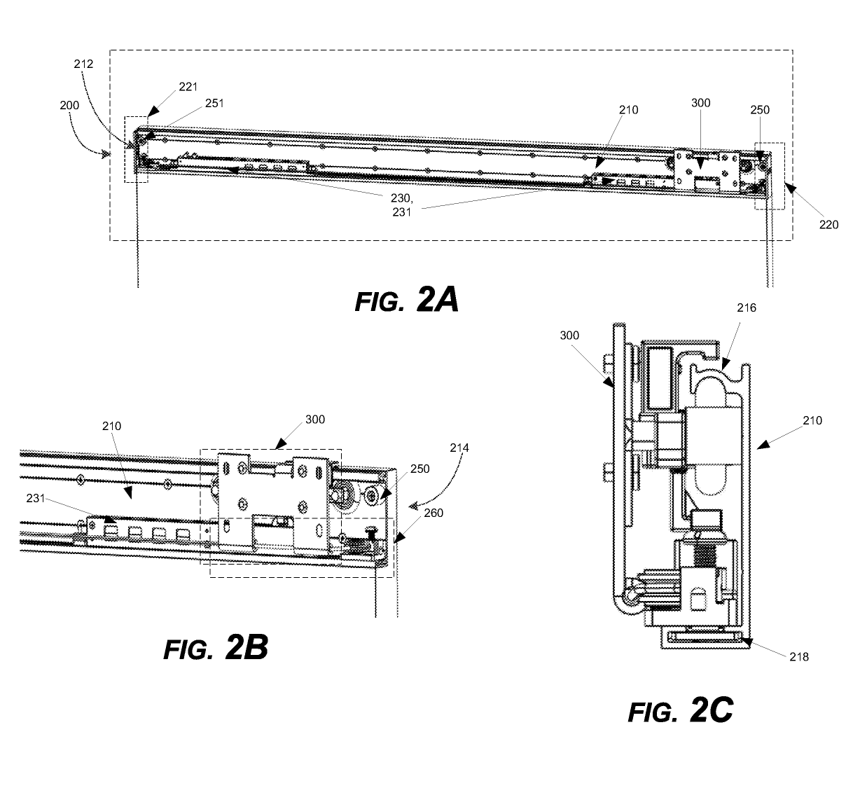

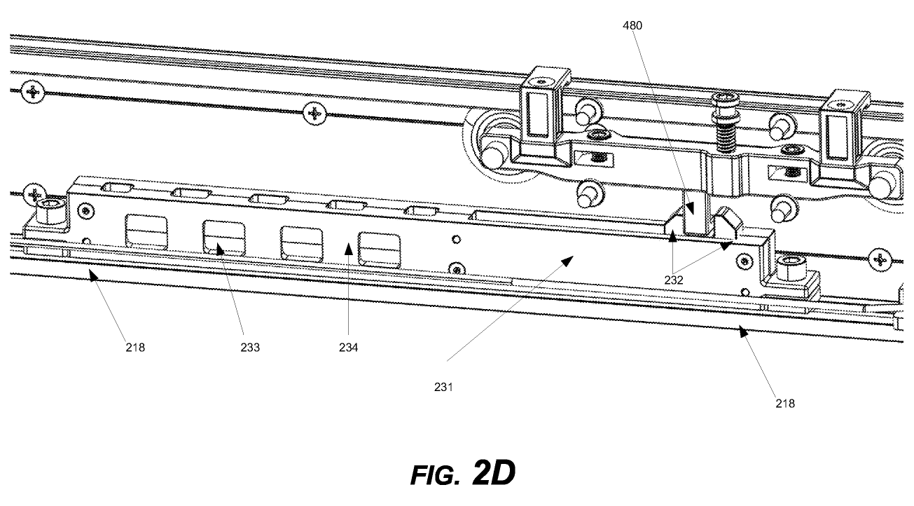

In conventional sliding door systems, hardware is mounted to a rear face or top edge of a sliding door and/or to an exposed surface (e.g., wall, frame, or the like) above the top edge of the sliding door, which results in hardware that is exposed, requires greater surface area to attach the hardware, and/or requires additional assembly time. The present invention remedies these problems by providing a hidden slide assembly 200 and/or a bottom slide assembly 500 that is at least partially (or mostly) hidden during operation of the sliding door 110 and/or allows for improved assembly (e.g., requires less wall space, less connections, and/or reduced installation time). As illustrated in FIGS. 1B-1C, the rear face 140 of the door 110 may comprise a channel 120 (e.g., a groove, a trench, a miter, or the like) adjacent the top edge 150 (e.g., within the back face 140 and/or the top edge 150). The channel 120 may be any type of shape, such as an L-shaped channel 120, however, it should be understood that the channel 120 may have any shape (e.g., u-shaped, c-shaped, v-shaped, or the like). The channel 120 may extend at least partially transversely between the leading edge 170 and the trailing edge 180 (or entirely between these edges). The channel 120 may be configured to receive at least a portion of hidden slide assembly 200 (e.g., the upper track 210 as described in greater detail with respect to FIGS. 2A-2C, or the like). In some embodiments, the sliding door 110 may not have a channel 120, and instead the hidden slide assembly 200 (e.g., the upper track 210, or the like) may be coupled to the rear face 140 of the sliding door 110. However, as illustrated in FIG. 1C, by recessing at least of a portion of the hidden slide assembly 200 within the channel 120, the hidden slide assembly 200 may be at least partially concealed from the view of users of the sliding door 110. Additionally, the channel 120 may reduce (e.g., minimize, or the like) the offset between the sliding door 110 and a door opening surface 101 (e.g., wall, door frame, or the like).

As illustrated in FIGS. 1D and 1E, the sliding door 110 may be configured to move (e.g., slide or glide) along a movement path 104 in order to selectively cover or expose an opening 103. The opening 103 may comprise an aperture or the like in the door opening surface 101 (e.g., a wall, frame, vertical support surface, or the like). As illustrated in FIG. 1D, the door 110 may move in a first direction along the movement path 104 (e.g., to cover the opening 103), and in a second direction along the movement path 104 (e.g., to uncover or expose the opening 103). As illustrated in FIG. 1E, one or more components of the hidden sliding door system 100 may be coupled to the door opening surface 101 and/or a floor 102 (e.g., a bottom surface, threshold, or the like). As described in greater detail herein, a hanger mount 310 of a hanger assembly 300 may be coupled to the door opening surface 101 (e.g., wall, support therein, or the like). Furthermore, in some embodiments, one or more bottom guide(s) 520 may be coupled to the floor 102 (e.g., flooring, sub-floor, supports thereof, or the like).

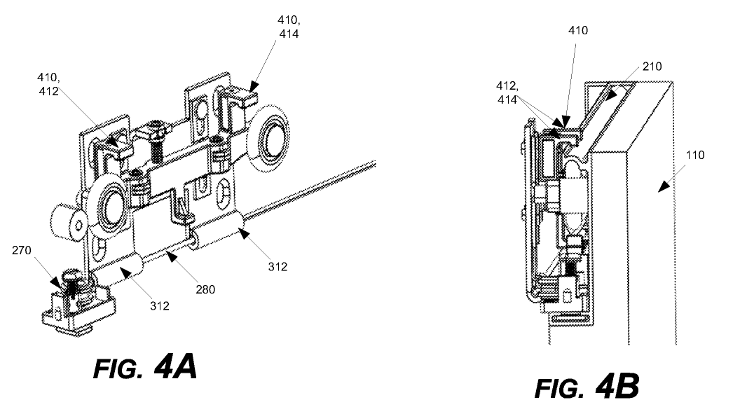

As illustrated in FIGS. 2A-2C and 4B, the hidden slide assembly 200 may comprise an upper track 210, one or more end caps (e.g., first and second end caps 220, 221, or the like), one or more soft-close assemblies (e.g., first and second soft-close assemblies 230, 231, or the like), a hanger assembly 300, and one or more slide stops (e.g., first and second slide stops 250, 251, or the like). The upper track 210 may be positioned within the upper channel 120 and may be coupled to the sliding door 110 (e.g., a surface of the channel 120, rear face 140 of the door 110, or the like) using a connector (e.g., a fastener, such as a screw, bolt, nail, nut, rivet, or the like, a weld, interference connection, clamp, clip, or other like connection). The upper track 210 may comprise a leading track end 212 adjacent the leading edge 170 of the door 110 and a trailing track end 214 adjacent the trailing edge 180 of the door 110. The first and second end caps 220 and 221 may be removably coupled to the upper track 210 (e.g., the leading track end 212 and trailing track end 214, respectively), or the sliding door 110 (e.g., leading edge 170 of the door, the trailing edge 180 of the door, respectively, the top edge 150, a surface of the channel 120, or the like). The first and second end caps 220 and 221 may cover at least a portion of the hidden slide assembly 200.

As illustrated in FIG. 2C, the upper track 210 may have a substantially C-shaped profile, although it should be understood that the upper track 210 may have any type of shape (e.g., E-shaped, L-shaped, U-shaped, W-shaped, V-shaped, and/or the like) configured to engage with one or more components of the hidden slide assembly 200. For example, the upper track 210 may comprise an upper edge 216 configured to extend towards the door opening surface 101 and to removably engage with one or more components of the hanger assembly 300 (e.g., the one or more rollers 420 and/or the secondary safety assembly 410 as will described in greater detail herein). The upper track 210 may further comprise a lower edge 218 configured to extend towards the door opening surface 101 and coupled to one or more components of the hidden slide assembly 200 (e.g., the primary safety assembly 260 and/or the first and second soft-close assemblies 230).

The first and second slide stops 250 and 251 may be coupled to the leading track end 212 and trailing track end 214, respectively. The one or more slide stops 250, 251 may restrict the movement of the sliding door 110 as the upper track 210 slides with respect to hanger assembly 300. For example, the one or more slide stops 250, 251 may engage a portion of the hanger assembly 300, such as the rollers of the hanger assembly 300, as illustrated in FIG. 2A. However, the slide stops may engage another portion of the hanger assembly 300, such as the hanger mount 310 and/or hanger carriage 400 to allow additional travel of the sliding door 110. As illustrated in FIGS. 2A-2B, the slide stops 250, 251 may be circular in shape, although other shapes (e.g., a half-circle, square, pin, uniform, non-uniform, or the like) are also contemplated. The stops 250, 251 may be made of any material to aid in engaging the hanger assembly, such as rubber, plastic, metal, composite, or other suitable material.

As illustrated in FIGS. 2A and 2D, the first and second soft-close assemblies 230, 231 may be positioned adjacent and coupled to the leading track end 212 and the trailing track end 214, respectively. The first and second soft-close assemblies 230, 231 may be configured to aid in slowing the movement of the sliding door 110 (e.g., damping the speed of the door during closing or opening) as it slides with respect to the hanger assembly 300 and as the first or second roller stops 250, 251 approach a portion of the hanger assembly 300. For example, as illustrated in FIG. 2D, the first and second soft-close assemblies 230, 231 may each be coupled to the lower edge 218 of the upper track 210. Furthermore, the first and second soft-close assemblies 230, 231 may each comprise damping elements 233, such as springs, pistons, or the like, configured to removably couple (e.g., engage and/or disengage) with the hanger assembly 300 to dampen (e.g., absorb, or the like) the force and/or speed at which the sliding door 110 is closed and/or opened. In some embodiments, as illustrated in FIG. 2D, the damping elements 233 may be positioned within (e.g., interior to) a soft-close assembly housing 234. Furthermore, as illustrated in FIG. 2D, the soft-close assemblies 230 may be activated (as well as set) by removeable coupling between a trigger 232 of the soft close assemblies 230, 231 and a portion of the hanger assembly 300, such as a hanger projection (e.g., a trigger arm 480). The trigger 232 may be a pivoting member, which when activated by the hanger assembly 300 (e.g., the trigger arm 480), pivots to activate the damping element 233 (e.g., spring, piston, combinations thereof, or the like) to aid in slowing the movement of the sliding door 110. Moreover, when the damping element 233 is set (as the door moves from closed to opening, or opened to closing) the movement of hanger assembly 300 (e.g., the hanger projection) may continue to engage the trigger 232 until the damping element is set at which point the hanger assembly 300 disengages from the trigger 232. Thus, the first and second soft-close assemblies 230, 231 may provide a smoother deacceleration of the door 110 as it is being fully opened or being fully closed.

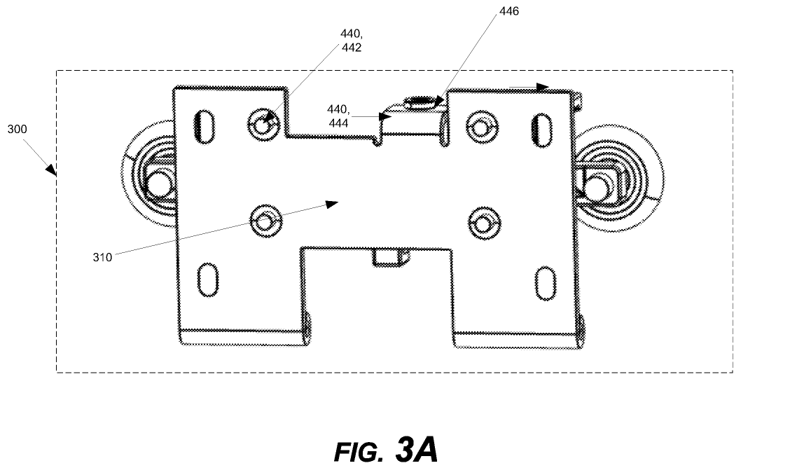

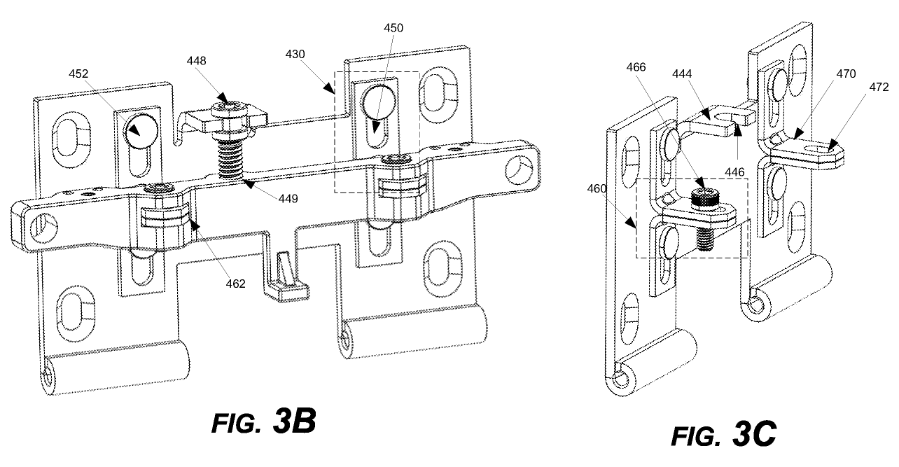

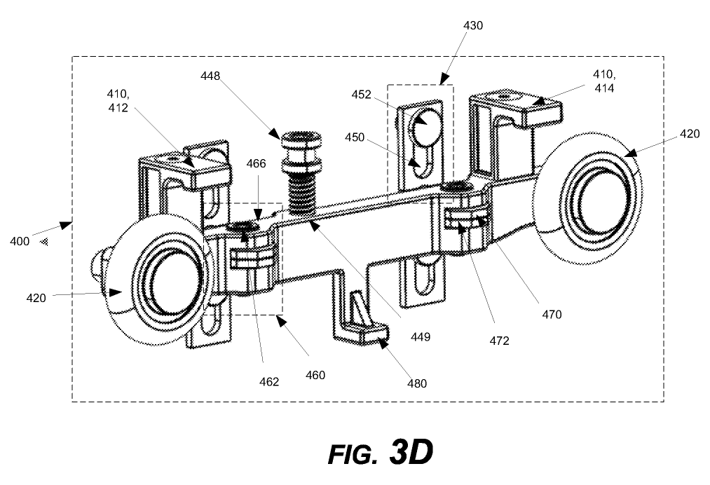

As illustrated in FIGS. 3A-3D, the hanger assembly 300 may comprise a hanger mount 310 coupled to the door opening surface 101 (e.g., a wall, door frame, or the like), and a hanger carriage 400 coupled to the upper track 210. As such, when the sliding door 110 moves with respect to the door opening surface 101, the upper track 210 slides with respect to the hanger carriage 400 between the first and second roller stops 250, 251. The hanger mount 310 may be coupled to the door opening surface 101 via connectors (e.g., fasteners, such as screws, bolts, anchors, nuts, or the like, clips, clamps, and/or other like connectors).

The hanger carriage 400 may be removably and/or adjustably coupled to the hanger mount 310 via one or more vertical adjustment assemblies 430 and one or more planar adjustment assemblies 460. A vertical adjustment assembly 430 may comprise one or more vertical adjustment mounts 440 on the hanger mount 310, which may comprise a vertical connector aperture 442 (e.g., an open hole, a through hole, or the like). Moreover, the one or more vertical adjustment mounts 440 may comprise a portion of the hanger mount 310 (e.g., a tab mount 444, or the like) located orthogonally to the door opening surface 101) having a vertical adjustment aperture 446 (e.g., an open hole, a through hole, or the like) in the hanger mount 310 (e.g., in the tab mount 444). Furthermore, the one or more vertical adjustment mounts 440 of the vertical adjustment assembly 430 may further comprise one or more vertical slide apertures 450 (e.g., slotted holes, or the like) on the hanger carriage 400. The vertical connector aperture 442 and the vertical slide aperture 450 may be coupled together via a slide connector 452 (e.g., a fastener, such as a screw, bolt, nut, rivet, or the like). Furthermore, the hanger mount 310 may be adjustably coupled with the hanger carriage 400 through a vertical adjustment connector 448 (e.g., a fastener, such as a screw, bolt, nut, rivet, or the like) that adjustably couples to the vertical adjustment aperture 446 of the vertical adjustment mount 440 (e.g., the tab mount 444) and the carriage 400 through a vertical carriage adjustment aperture 449 (e.g., threaded aperture, or the like). In some embodiments a vertical carriage adjustment aperture 449 may not be used, and instead the vertical adjustment connector 448 may be coupled with a surface of the hanger carriage 400. In still other embodiments, while a single vertical adjustment connection 448 and/or vertical carriage adjustment aperture 449 are illustrated, the hanger assembly 300 may include two or more vertical adjustment connections 448 and/or two or more vertical carriage adjustment apertures 449. By adjusting the vertical adjustment connector 448 (or multiple vertical adjustment connectors 448), the hanger carriage 400 may move vertically with respect to the hanger mount 310 as the one or more vertical adjustment apertures 450 slide with respect to the one or more slide connectors 452. As such, the height of hanger carriage 400 with respect to the hanger mount 310 may be adjusted in order to adjust the position of the sliding door 110 with respect to the floor 102. In some embodiments, by providing two or more vertical adjustment assemblies 430, the heights of two ends of the hanger carriage 400 may be adjusted vertically with respect to each other.

While a specific vertical adjustment assembly 430 is illustrated in the figures, it should be understood that other types of vertical adjustment assemblies 430 may be utilized, in which the components of the vertical adjustment assemblies 430 may be reversed (e.g., with respect to the hanger mount 310 and/or the hanger carriage 400) and/or other types of components (e.g., cams, gears, slidable connectors, adjustable springs, and/or the like) may be used to allow the hanger carriage 400 to move vertically (up or down) with respect to the hanger mount 310. Furthermore, in some embodiments, the one or more vertical adjustment assemblies 430 may be accessible when the hidden sliding door system 100. 100 is in an installed configuration (e.g., when the hanger mount 310 is coupled to the door opening surface 101 and the sliding door 110 is coupled to the hanger mount), such that the height of the door 110 from the floor 102 is adjustable (e.g., to account for an uneven surface of the floor 102 and/or to ensure that the door 110 moves smoothly across the movement path 104).

The one or more planar adjustment assemblies 460 (otherwise described as one or more horizontal adjustment assemblies 460) may comprise one or more horizontal adjustment mounts 470 on the hanger mount 310, which may comprise a horizontal adjustment mount aperture 472 (e.g., slotted hole, or the like) positioned orthogonally to the door opening surface. Each planar adjustment assembly 460 may further comprise a horizontal adjustment carriage aperture 462 on the hanger carriage 400, which may be positioned parallel to the door opening surface 101. The horizontal adjustment mount 470 may extend through the horizontal adjustment carriage aperture 462 in the hanger carriage 400 (or otherwise be located above or below the hanger carriage 400) and be adjustably coupled together via a horizontal adjustment connector 466 (e.g., a fastener, such as a screw, bolt, nut, or the like, clamp, clip, or the like). By adjusting the horizontal adjustment connector 446 (e.g., loosening or tightening, or the like), the horizontal position of the hanger carriage 400 may be moved horizontally as the horizontal adjustment connector 446 slides within the horizontal adjustment mount aperture 472 in the horizontal adjustment mount 470 and/or the horizontal adjustment mount 470 slides within the horizontal adjustment carriage aperture 462. As such, the distance and/or angle between the hanger carriage 400 and the hanger mount 310 may be adjusted.

In some embodiments, as illustrated in FIGS. 3A-3C, by providing two or more planar adjustment assemblies 460, the distance between a first end of the hanger carriage 400 and the hanger mount 310 may be adjusted independently of the distance between a second end of the hanger carriage 400 and the hanger mount 310. While a specific planer adjustment assembly 460 is illustrated in FIGS. 3A-3C, it should be understood that other types of planer adjustment assemblies 460 may be utilized, in which the components of the horizontal adjustment assembly 460 may be reversed (e.g., with respect to the hanger mount 310 and/or the hanger carriage 400) and/or other types of components (e.g., cams, gears, slidable connectors, adjustable springs, and/or the like) may be used to allow the hanger carriage 400 to move horizontally and/or at an angle with respect to the hanger mount 310. Furthermore, in some embodiments, the one or more planar adjustment assemblies 460 may be accessible when the hidden sliding door system 100 is in an installed configuration (e.g., when the hanger mount 310 is coupled to the door opening surface 101 and the sliding door 110 is coupled to the hanger mount 310), such that a distance of the door 110 from the door opening surface 101 is adjustable (e.g., to account for an uneven surface of the door opening surface 101 and/or to ensure that the door 110 moves smoothly across the movement path 104).

As illustrated in FIGS. 3A-3D, at least a portion of the one or more vertical adjustment assemblies 430 and/or the one or more planer adjustment assemblies 460 may be coupled and/or share components. For example, the one or more vertical adjustment mounts 440 and/or the one or more horizontal adjustment mounts 470 having the apertures described herein may be the same mounts, different mounts, and/or mounts that are coupled together. For example, as illustrated in FIG. 3C, the mounts may be an L-shaped bracket having a vertical adjustment leg (or tab) and a horizontal adjustment leg (or tab) with the respective apertures therein. Two or more of the L-shaped brackets (e.g., illustrated as four) may be used to provide the vertical adjustment and/or horizontal adjustments described herein.

As illustrated in FIG. 3D, the hanger carriage 400 may further comprise one or more rollers 420 configured to removably engage with the upper track 210. For example, as described above, the upper track 210 may comprise a C-shaped channel (or other shaped channel), and the one or more rollers 420 may be configured to fit within and support the C-channel of the upper track 210. The one or more rollers may comprise wheels, bearings, and/or the like configured to allow the upper track 210 to glide, slide, or roll smoothly over the one or more rollers 420 as the upper track 210 moves with respect to the hanger assembly 300.

As illustrated in FIG. 4A, the hidden slide assembly 200 may further comprise a primary safety assembly 260 and/or a secondary safety assembly 410. The primary safety assembly 260 may comprise one or more tension adjustment mechanisms 270 and a flexible member 280. In some embodiments, the hanger assembly 300 (e.g., the hanger mount 310, hanger carriage 400, or the like) may further comprise one or more safety guides 312 configured to engage with the flexible member 280. The flexible member 280 may comprise a cable, chain, wire, rod, spring, and/or the like, and may be coupled to the hanger assembly 300 and the door 110. As such, in some embodiments the flexible member 280 may be completely flexible or only partially flexible (e.g., a wire combined with a rod, or the like). In the event that the hanger carriage 400 uncouples (e.g., disengages, or the like) from the upper track 210, the hanger carriage 400 fails, and/or the hanger carriage 400 becomes uncoupled (e.g., disengages, or the like) from the hanger mount 310, the flexible member 280 restricts (e.g., prevents, limits, or the like) the door 110 from falling off of the door opening surface 101. In some embodiments, the guides 312 may comprise a member (e.g., tubular member, hook members, or the like) having an opening, allowing the flexible member 280 to be coupled to the guides 312 (e.g., to loop around, pass therethrough, or the like). It should be understood that the guides 312 (e.g., the tubular member, hook member, or the like) may have any shape (e.g., circular, half-circular, u-shaped, v-shaped, c-shaped, triangular, square, rectangular, polygonal, uniform, non-uniform, or the like). In some embodiments, instead of the guides 312 being located on the hanger mount 310, the guides may be coupled to a safety assembly mount (e.g., bracket, or the like) that is coupled to the opening door opening surface 101 adjacent to or separate from the hanger mount 310. For example, the safety assembly mount may be a separate mount different than the hanger mount 310 which includes the guides 312.

The flexible member 280 may be coupled to the door 110 adjacent the leading track end 212 and/or the trailing track end 214 (e.g., to the sliding door 110 and/or the upper track 210). In some embodiments, the flexible member 280 may be coupled to the door 110 via one or more tension adjustment mechanism(s) 270. The tension adjustment mechanism(s) 270 may comprise clamps, clips, brackets, pulleys, wound rollers, biasing members (e.g., springs, or the like), or similar components configured to hold the flexible member 280 in place and to provide an adjustable degree of tension to the flexible member 280. For example, the tension adjustment mechanism(s) 270 may allow the flexible member 280 to be loosened to provide access to the hidden slide assembly 200 during, for example, installation or repair (e.g., the door may be held upright while being installed, repair, inspected, or the like). The tension adjustment mechanism(s) 270 may further allow the flexible member 280 to be tightened to provide a greater degree of safety during typical operation of the hidden sliding door system 100. It should be understood that the tensioning adjustment mechanism(s) 270 may provide for manual, semi-automatic, and/or automated tensioning adjustment of the flexible member 280.

As illustrated in FIG. 4B, the hidden slide assembly 200 may further comprise a secondary safety assembly 410. The secondary safety assembly 410 may comprise first and second arms 412, 414 that extend from the hanger assembly 300 (e.g., from the hanger carriage 400, or the like) outwardly away from the hanger mount 310 and towards the upper track 210 of the sliding door 310. As illustrated, the first and second arms 412, 414 may extend outward of the hanger carriage 400 and over at least a portion of the track 210 (e.g., over a safety projection, such as an upper edge 216 of the upper track 210). Thus, in the event that the hanger carriage 400 fails, the hanger carriage 400 disengages from the upper track 210, the primary safety assembly 270 fails, and/or another like event occurs, the first arm 412 and/or second arm 414 may be configured to engage with the upper track 210 to restrict the door from falling away from the door opening surface 101. The first arm 412 and/or the second arm 414 may be adjustable through the use of an arm connector (e.g., fastener, other coupling) that allow the first arm 412 and/or the second arm 414 to be removed, installed, adjusted, or the like for assembly, disassembly, or adjustment of the systems, including the secondary safety assembly 410. For example, the first arm 412 and/or the second arm 414 may be moved away when installing the door 110, and moved back into position after the door 110 is installed.

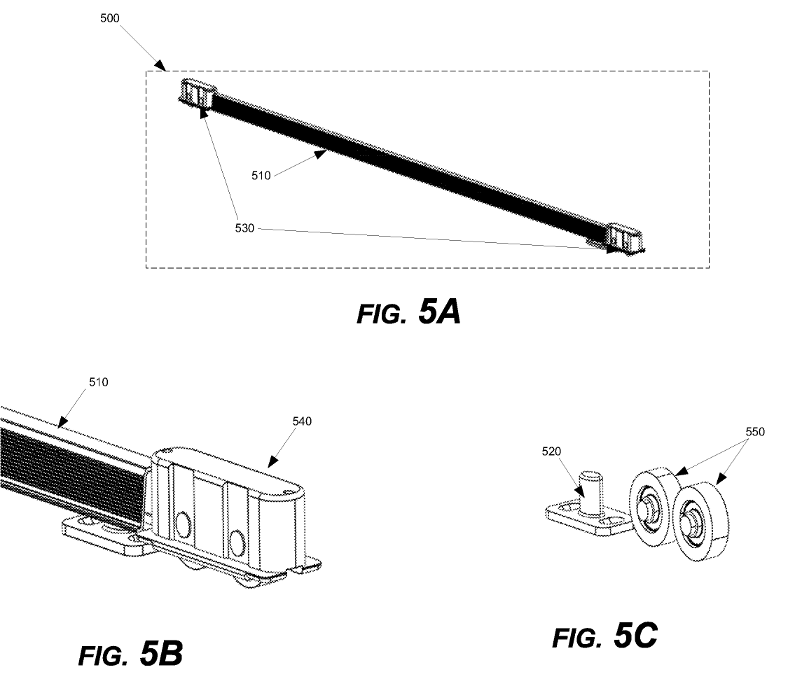

As illustrated in FIGS. 5A-5C, the hidden sliding door system 100 may further comprise a bottom slide assembly 500. The bottom slide assembly 500 may be located at least partially within one or more bottom channels 162 (e.g., apertures, groves, or the like) located adjacent the bottom edge 160 of the sliding door 110 (e.g., within the bottom edge, near the bottom edge in the front face 130 or rear face 140 of the sliding door 110, or the like). The bottom slide assembly 500 may comprise a bottom track 510 and one or more roller assemblies 530, which may be positioned within the one or more bottom channels 162 adjacent the bottom edge 160 of the sliding door 110, such that the bottom slide assembly 500 is at least partially hidden from users when viewing the rear face 140 and/or the front face 130 or the sliding door 110. The bottom track 510 may comprise a U-shaped member, however, it should be understood that the bottom track 510 may have any type of shape (e.g., u-shaped, n-shaped, v-shaped, or other similar shape) configured to allow one or more bottom guide(s) 520 to fit within the bottom track 510. The bottom guide(s) 520 may comprise guide pins, stoppers, or the like which are coupled to a floor 102 (e.g., material on the floor, sub-floor, floor support, a threshold, or other floor surface), and which are configured to restrict a sliding lateral path of movement of the door 110 by restricting (e.g., preventing, limiting, or the like) the bottom edge 160, the bottom track 510, and/or the one or more roller assemblies 530 from sliding past the bottom guide(s) 520. The bottom guide(s) 520 may also restrict movement of the door 110 towards or away from door opening surface 101 by engaging with the interior sides of the bottom channel 162 and/or the bottom track 510 located therein.

As illustrated in FIGS. 5B-5C, the at least one roller assembly 530 may include a roller housing 540 configured to house one or more roller(s) 550. The roller(s) 550 may comprise rollers, wheels, ball bearings, or any similar component suitable for allowing the roller assembly 530 to roll or slide across a surface. The one or more roller assemblies 530 are illustrated as having a leading edge roller assembly and a trailing edge roller assembly in order to account for uneven floor surfaces (e.g., one roller assembly may be engaged with the floor to maintain at least one point of contact). However, it should be understood that in some embodiments only one roller assembly 530 may be used and/or the one or more roller assemblies 530 may be located at different locations adjacent the bottom edge 160 (e.g., at different positions between the leading edge 170 and trailing edge 180 of the sliding door 110). Additionally, or alternatively, the one or more roller assemblies 530 may include biasing members (e.g., springs, elastomer blocks, dampers, or the like) that allow for movement (e.g., vertical, horizonal, diagonal, or the like) of the one or more rollers 550 to account for floor surfaces that may be uneven.

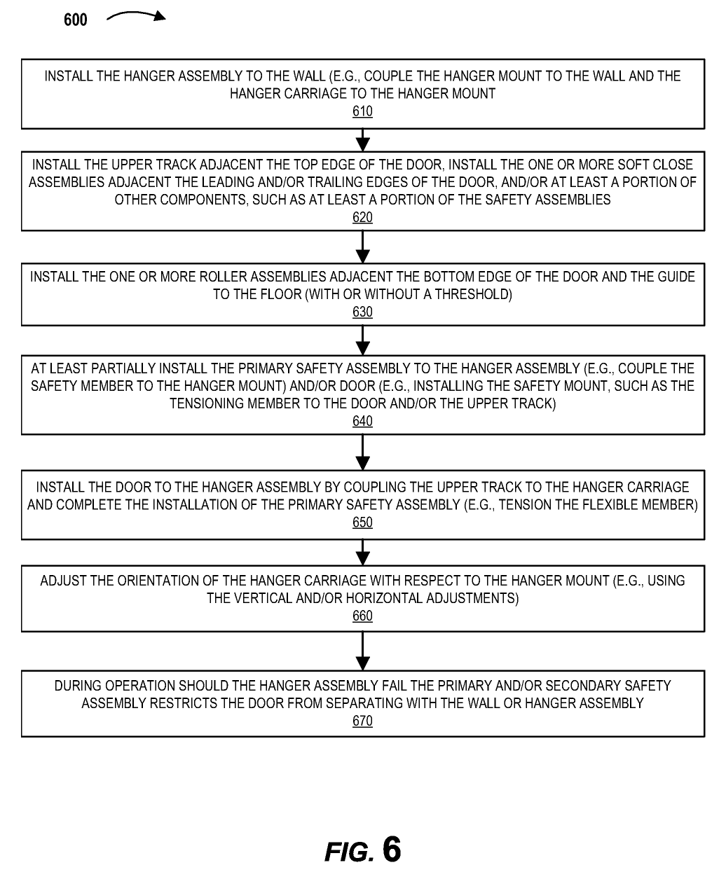

FIG. 6 illustrates a process flow 600 for a method of installing the hidden sliding door system 100, in accordance with embodiments of the present disclosure. The method may begin at block 610, by installing the hanger assembly 300 to the door opening surface 101. Specifically, block 610 may include coupling the hanger mount 310 to the door opening surface 101 (e.g., via connectors, such as fasteners - screws, bolts, anchors, welds, or the like – clips, clamps, and/or other like connectors). The hanger mount 310 may be coupled to the door opening surface 101 at a predetermined height above the floor 102 and at a predetermined distance from the opening 103. For example, the position of the hanger mount 310 relative to the floor 102 and the opening 103 may be determined based on one or more specifications of the door 110 (e.g., height, width, or the like). Then, the hanger carriage 400 may be at least partially coupled to the hanger mount 310 via the one or more vertical adjustment assemblies 430 and the one or more planar adjustment assemblies 460. The exact positioning of the hanger carriage 400 with respect to the hanger mount 310 may be further adjusted in subsequent steps, as described in greater detail below.

The method may then continue to block 620, which may include installing the upper track 210 adjacent the top edge 150 of the door 110. In some embodiments, the upper track 210 may be pre-installed (otherwise described as pre-assembled) to the sliding door 110 during manufacturing and/or before shipping of the door 110. In some embodiments, the upper track 210 may be installed within the upper channel 120 of the door and/or on the rear face 140 of the door. The upper track 210 may be coupled to the door 110 via a connector (e.g., a fastener, such as a screw, bolt, nail, nut, rivet, or the like, a weld, interference connection, clamp, clip, or other like connection). Block 620 of the method may further include installing the one or more soft close assemblies 230, 231 adjacent the leading and/or trailing edges 170, 180 of the door 110. The one or more soft close assemblies 230, 231 may be coupled to the lower edge 218 of the upper track 210 via a connector (e.g., a fastener, such as a screw, bolt, nail, nut, rivet, or the like, a clamp, clip, or other like connection). Block 620 of the method may further include installing the first and second slide stops 250, 251 to the upper track 210 via a connector (e.g., a fastener, such as a screw, bolt, nail, nut, rivet, or the like, a clamp, clip, or other like connection). Additionally, or alternatively, the soft close assemblies 230, 231 and/or the slide stops 250, 251 may be pre-installed to the upper track 210 (e.g., during manufacturing).

The method may then continue to block 630, which may include installing the one or more roller assemblies 530 adjacent the bottom edge 160 of the door 110. In some embodiments, the one or more roller assemblies 530 may be pre-installed to the sliding door 110 during manufacturing and/or before shipping of the door 110. For example, block 630 may include positioning the bottom track 510 within the bottom channel 162 and installing the one or more roller assemblies 530 within the bottom track 510. In some embodiments, the bottom track 510 may be pre-assembled within the bottom channel 162 (e.g., during manufacturing). Block 630 may further include installing the bottom guide(s) 520 to the floor 102 via a connector (e.g., a fasteners, such as a screw, nail, bolt, and/or the like, or other like connector). As with the hanger mount 310, the bottom guide(s) 520 may be installed at a predetermined distances from the door opening surface 101 and/or the opening 103, according to one or more specifications of the door 110 (e.g., width, depth, or the like) and/or the door opening surface 101.

The method may then continue to block 640, which may include at least partially installing the primary safety assembly 260 to the hanger assembly 300. In some embodiments, partially installing the primary safety assembly 260 includes coupling the flexible member 280 to the hanger mount 310 (e.g., coupling the flexible member 280 to the safety guide(s) 312) and/or the coupling the flexible member 280 to the door 110 (e.g., by installing the tensioning member(s) 270 to the upper track 210 and coupling the flexible member 280 to the tensioning member(s)). The flexible member 280 may be coupled to the tensioning member(s) by a flexible member connector (e.g., fasteners, such as screws, bolt, nails, rivets, or the like, a clamp, clip, or the like), and/or the flexible member 280 may be tensioned (e.g., pulled, tightened, stretched, or the like) within, over, and/or around the tensioning member(s). In some embodiments, where the system includes a first tensioning member and/or second tensioning member, partially installing the primary safety assembly may include coupling the flexible member 280 to one of the first and second tensioning members. Alternatively, partially installing the primary safety assembly may include coupling the flexible member 280 to both the first and second tensioning members at a relatively low degree of tension (e.g., less tension than a fully installed position as described in greater detail below).

The method may then continue to block 650, which may include installing the door 110 to the hanger assembly 300 by coupling the upper track 210 to the hanger carriage 400. For example, block 650 may include positioning the one or more roller(s) 520 underneath the upper edge 216 of the upper track 210. At the same time, or at a different time the bottom track 510 (or bottom channel 162) may be engaged with the one or more bottom guide(s) 520 (e.g., slid onto, the bottom guides may be extended, rotated into position, or the like). Once the one or more roller(s) 520 are coupled to the upper track 210 and/or the bottom track 510 and one or more bottom guide(s) 520 are coupled, block 650 may further include completing the installation of the primary safety assembly 280 (e.g., by coupling the flexible member to the second tensioning member, to the hanger assembly 300, and/or by tensioning the flexible member 280 to a relatively high degree of tension compared to the previous step).

The method may then continue to block 660, which may include adjusting the orientation of the hanger carriage 400 (and thus the sliding door 110) with respect to the hanger mount 310 (e.g., using the vertical adjustment assemblies 430 and/or planar adjustment assemblies 460). For example, as described in greater detail with respect to FIGS. 3A-3D, by adjusting the vertical adjustment connector 448 (e.g., loosening or tightening), the hanger carriage 400 may move vertically with respect to the hanger mount 310 as the one or more vertical adjustment apertures 450 slide with respect to the one or more slide connectors 452. For example, the height of hanger carriage 400 with respect to the hanger mount may be adjusted in order to adjust the position of the sliding door 110 with respect to the floor 102. Furthermore, the heights of two ends of the hanger carriage 400 may be adjusted vertically with respect to each other. Additionally, or alternatively, by adjusting the horizontal adjustment connector 446 (e.g., loosening or tightening), the horizontal position and/or angular position of the hanger carriage 400 may be moved as the horizontal adjustment connector 446 slides within the horizontal adjustment mount aperture 472 in the horizontal adjustment mount 470. Thus, the distance and/or angle between the hanger carriage 400 and the hanger mount 310 may be adjusted to allow the door 110 to move smoothly (e.g., uninterruptedly) along the movement path 104. In some embodiments, adjusting the orientation of the hanger carriage 400 with respect to the hanger mount 310 may occur before installation of the primary safety assembly (or at a least a portion thereof).

The method may then conclude at block 670, where, in the event that a component and/or coupling of the hidden slide assembly 200 fails (e.g., during operation of the door), the primary and/or secondary safety assemblies restrict the door from separating from the door opening surface 101 and/or the hanger assembly 300. For example, if the hanger carriage 400 becomes uncoupled from the upper track 210 and/or from the hanger mount 310, the flexible member 280 of the primary safety assembly may prevent the door 110 from separating from (e.g., falling away from) the door opening surface 101. Additionally, or alternatively, the first arm 412 and/or second arm 414 of the hanger carriage 400 may be engage with the upper edge 216 of the upper track 210 to restrict the door from falling away from the door opening surface 101.

It should be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa.

Where possible, any terms expressed in the singular form herein are meant to also include the plural form and/or vice versa, unless explicitly stated otherwise. Accordingly, the terms “a” and/or “an” shall mean “one or more.”

Moreover, it should be understood that “coupled,” when used herein, means that the components may be formed integrally with each other, or may be formed separately and coupled together. Furthermore, “coupled” means that the components may be coupled directly to each other, or to each other with one or more components located between the components that are coupled together. Furthermore, “coupled” may mean that the components are detachable from each other, or that they are permanently coupled together.

Furthermore, certain terminology is used herein for convenience only and is not to be taken as a limiting, unless such terminology is specifically described herein for specific embodiments. Indeed, the components may be oriented in any direction and the terminology, therefore, should be understood as encompassing such variations unless specified otherwise. The terminology includes the words specifically mentioned herein, derivatives thereof and words of similar import. For example, words such as “top”, “bottom”, “upper”, “lower”, “side”, “vertical”, “horizontal”, “first”, “second”, or the like are used to describe the orientation of certain features as illustrated in the figures. Moreover, words such as “primary,” “secondary,” or the like do not indicate that one is more important than the other, or that the features cannot be used alone without the other (e.g., only primary or only secondary).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A sliding door system, the system comprising:
a door having a front face, a rear face, a top edge, a bottom edge, a leading edge, and a trailing edge;
a hidden slide assembly, the hidden slide assembly comprising:
an upper track coupled adjacent the top edge of the door, the upper track comprising a leading track end adjacent the leading edge of the door and a trailing track end adjacent the trailing edge of the door; and
a hanger assembly comprising:
a hanger mount coupled to a wall; and
a hanger carriage coupled to the hanger mount and the upper track; and
a bottom slide assembly coupled adjacent the bottom edge of the door.

2. The sliding door system of claim 1, wherein the hidden slide assembly further comprises:
a primary safety assembly, the primary safety assembly comprising:
a flexible member coupled adjacent the leading edge or the trailing edge of the door, and coupled to the hanger mount or a safety mount;
wherein the flexible member restricts the door from disengaging with the hanger mount or the safety mount when the hanger carriage disengages from the upper track, when the hanger carriage disengages from the hanger mount, or when the hanger carriage fails.

3. The sliding door system of claim 2, wherein the hanger mount comprises one or more guides, and wherein the one or more guides are coupled to the flexible member.

4. The sliding door system of claim 3, wherein a guide of the one or more guides comprises:
a tubular member having an opening, wherein the flexible member passes through the opening.

5. The sliding door system of claim 2, wherein the primary safety assembly further comprises:
one or more tensioning assemblies, a tensioning assembly comprising:
a tension adjustment mechanism configured to tension or loosen the flexible member.

6. The sliding door system of claim 5, wherein the primary safety assembly further comprises:
a first tensioning assembly coupled to the leading track end; and
a second tensioning assembly coupled to the trailing track end.

7. The sliding door system of claim 2, wherein the flexible member is coupled to the leading track end and the trailing track end.

8. The slide door system of claim 2, wherein the flexible member comprises at least a portion that is flexible.

9. The sliding door system of claim 2, wherein the hidden slide assembly further comprises:
a secondary safety assembly, the secondary safety assembly comprising:
one or more arms coupled to the hanger mount or the hanger carriage and extending over the at least a portion of the upper track;
wherein when the hanger carriage disengages from the upper track or the hanger carriage fails, the one or more arms engage the portion of the upper track to restrict the door from disengaging with the hanger mount or the hanger carriage.

10. The sliding door system of claim 1, wherein the rear face comprises an upper channel extending transversely between the leading edge and the trailing edge of the door and the upper track is positioned within the upper channel.

11. The sliding door system of claim 1, wherein the hidden slide assembly further comprises:
a first roller stop coupled adjacent the leading edge of the door; and
a second roller stop coupled adjacent the trailing edge of the door;
wherein the hanger carriage has a travel path that is constrained between the first roller stop and the second roller stop.

12. The sliding door system of claim 1, wherein the hanger carriage further comprises:
one or more vertical adjustment assemblies, wherein each of the one or more vertical adjustment assemblies is configured to adjust a vertical position of a hanger carriage end of the hanger carriage with respect to the hanger mount.

13. The sliding door system of claim 12, wherein the one or more vertical adjustment assemblies comprise:
a vertical adjustment mount coupled to the hanger mount;
a vertical adjustment aperture formed by the hanger carriage; and
a threaded fastener coupled to the vertical adjustment mount and the vertical adjustment aperture.

14. The sliding door system of claim 1, wherein the hanger carriage further comprises:
one or more planar adjustment assemblies configured to adjust a distance between the hanger carriage and the hanger mount.

15. The sliding door system of claim 14, wherein a planar adjustment assembly of the one or more planer adjustment assemblies comprises:
a horizontal adjustment mount coupled to the hanger mount having a slotted aperture;
a horizontal adjustment aperture formed by the hanger carriage; and
a threaded fastener coupled to the horizontal adjustment mount and the horizontal adjustment aperture.

16. The sliding door system of claim 1, wherein the hanger assembly further comprises:
a first soft-close assembly coupled adjacent the leading edge of the door; and
a second soft-close assembly coupled adjacent the trailing edge of the door;
wherein the first soft-close assembly and the second soft-close assembly each comprise a damper configured to removably engage with the hanger carriage.

17. The sliding door system of claim 1, wherein the bottom slide assembly comprises:
one or more roller assemblies coupled adjacent the bottom edge of the door; and
one or more bottom guides coupled to the floor or adjacent the bottom edge of the door;
wherein the one or more roller assemblies support a weight of the door, and the one or more bottom guides are configured to maintain a consistent distance between the wall and the bottom edge of the door during opening and closing.

18. The sliding door system of claim 17, wherein the door comprises a bottom channel extending transversely between the trailing edge of the door and the leading edge of the door, wherein the channel is positioned within the bottom edge of the door;
wherein a bottom guide of the one or more bottom guides comprises a guide pin coupled to the floor; and
wherein the guide pin slides within the channel and restricts the bottom edge of the door from moving horizontally.

19. A method of installing the sliding door system of claim 1, the method comprising:
installing the hidden slide assembly to a door opening surface and the door.

20. A sliding door system for a door having a front face, a rear face, a top edge, a bottom edge, a leading edge, and a trailing edge, the system comprising:
a hidden slide assembly, the hidden slide assembly comprising:
an upper track configured to be coupled adjacent the top edge of the door, the upper track comprising a leading track end adjacent the leading edge of the door and a trailing track end adjacent the trailing edge of the door; and
a hanger assembly comprising:
a hanger mount configured to be coupled to a wall; and
a hanger carriage configured to be coupled to the hanger mount and the upper track; and
a bottom slide assembly configured to be coupled adjacent the bottom edge of the door.
